(19) United States
(12) Patent Application Publication
(10) Pub. No.: US 2005/0040006 A1
(43) Pub. Date: Feb. 24, 2005

(54) Table game validation and event audit system

(76) Inventors: Prashanth Kodela, Las Vegas, NV (US); Richard J. Iannello, Sebastopol, CA (US); James K. Bullock, Las Vegas, NV (US); Peter Hand, Las Vegas, NV (US); Gwen D. Mathis, Las Vegas, NV (US); Raymond Heidel, Henderson, NV (US)

Correspondence Address: David B. Abel, Esq.;SQUIRE, SANDERS & DEMPSEY, LLP, 14th Floor, 801 South Figueroa, Los Angeles, CA, 90017, US

(21) Appl. No.: 10/941,316

(22) Filed: Sep. 14, 2004

Related U.S. Application Data
(63) Continuation-in-part of application No. 10/081,756, filed on Feb. 20, 2002, now Pat. No. 6,745,887.

(51) Int. Cl. G07F 7/04

(52) U.S. Cl. 194/206

(57) ABSTRACT

A casino table game transaction management system for a plurality of gaming tables each having a dealer station and at least one player station, the system including bill acceptor assemblies adapted for utilization at the gaming tables, the bill acceptor assemblies each including a note transportation system, a note validator configured to identify characteristics of each note being passed therethrough by the transportation system, and a cash box adapted to receive and to store notes. The system also includes a casino computer configured to monitor transactions within the casino via a network interconnecting each of the bill acceptor assemblies at the gaming tables to the casino computer.

This application is a Continuation In Part of U.S. application Ser. No. 10/081,756, filed on Jun. 7, 2004 which is a Continuation of U.S. application Ser. No. 10/081,756, filed Feb. 20, 2002, entitled Gaming Table Validator Assembly, now U.S. Pat. No. 6,745,887.

### BACKGROUND OF THE INVENTION

1. Field of the Invention

The present invention is directed to a bill acceptor adapted for mounting on a gaming table and the validation and event audit system for use in a gaming establishment that automates the receipt, tracking and event audit process for gaming table transactions. Certain of the concepts herein are also useful in the field of kiosk dispensing assemblies and checkout counters. In particular, the invention relates to the design, operation and implementation of a bill acceptor which can accept a stack of individual notes in a receiving slot or bulk note feeder mounted to, or proximate, a gaming table, and alternatively accept other types of markers utilized in a gaming establishment to account for player use, and the method by which the validator processes the notes and markers and interacts with the back room auditing and control systems.

2. General Background and State of the Art

Conventional gaming tables located in casinos are generally used to play games such as blackjack, poker, roulette, baccarat, craps and Pai Gow. Variations on poker games include Crazyfor Poker, Let It Ride, Three Card Poker, Wild Hold'Em and 357 Poker. Generally, each gaming table may have an outer periphery containing a plurality of player locations and a table supervisor or dealer location located opposite the player locations. From the dealer's location, the dealer controls the pace and operation of the game including for example dealing the cards, paying winning wagers and collecting losing wagers. Gaming establishments generally cluster the table games in such a manner that a Pit Boss can oversee and monitor the action on a number of gaming tables simultaneously. A Pit Boss can thus be responsible for five to twenty different gaming tables.

The operation of a gaming establishment is highly regulated and strictly monitored. The oversight of several gaming tables by a Pit Boss is thus a complicated task in that the Pit Boss is responsible for knowing approximately how much money is in play on all of the gaming tables, and the Pit Boss must be keenly aware of players who exhibit suspicious behavior. These responsibilities often take precedence over the other responsibilities of a Pit Boss, including customer service and customer ratings to promote the casino and enhance the experience for the preferred customers.

In view of the present regulation of gaming, systems adapted for use in the gaming industry are required to meet very high design and reliability standards. New systems that allow automation of the responsibilities presently assigned to the dealers and the Pit Boss must be compatible with existing regulations and may become subject to new regulations that require modifications after implementation.

The supervisor or dealer for each table game also has a number of responsibilities, including accepting, counting and then exchanging currency or notes received from a player for casino chips. Generally, when a player wants to exchange currency or notes for chips at the gaming table, the player gives the currency or notes to the dealer. Notes, as used herein, can include local and foreign currency, casino scrip, and casino issued tickets. The dealer typically counts out and then spreads the currency or notes on the playing surface of the gaming table. Video surveillance systems view each of the tables and may be used to confirm the dealer's counting of received notes. The dealer is sometimes required to notify a Pit Boss when the dealer is exchanging currency or notes, typically when the amount is over a certain threshold. The Pit Boss in turn must maintain a running event audit of the money in play on each of the tables that he or she is supervising.

After receiving an approval from the Pit Boss, the dealer accepts the currency or notes and deposits them into a slot accessible from the playing surface of the gaming table. The slot leads to a channel for transporting the currency or notes from the slot to a cash box located below the playing surface. A plate may be used to push the currency or notes into the slot and ensure that the currency or notes properly fall into the cash box. Generally, the cash box beneath the gaming table does not include a stacking assembly to receive and stack, in an organized manner, the notes received. Thus, when the cash box is removed from the gaming table and taken to the counting room, the notes must be manually removed, sorted, stacked and counted. Gaming regulations may require that the receipts or cashbox on every table be audited at least once per day, thus requiring a manual sort and count for each active gaming table at least once per day.

The revenues received on the gaming tables are a significant source of income for a casino. Accordingly, the high volume of currency or notes exchanged invites the risks of receiving counterfeit currency or notes. Unlike slot machines, wherein the implementation of integrated bill acceptors in the slot machines has diminished the casinos' risk of receiving counterfeit currency, most gaming tables remain susceptible to this risk. Due to the increased sophistication of counterfeiters and the increasing difficulties in discriminating between authentic and counterfeit currency, the manual or dealer inspection method of accepting currency on gaming tables is inadequate to protect casinos from currency fraud.

Further, as the use of casino scrip and casino cash voucher tickets increases, or other types of cash equivalents are adopted, there is a risk that these forms of notes will be compromised or counterfeited. Many casinos or gaming establishments now have “ticket out” systems installed in their slot machines. Such systems are described, for example, in U.S. Pat. No. 6,048,265 hereby incorporated by reference. Generally, when a player wishes to cash out in a ticket out game, the casino's central computer system issues a tracking number to the slot machine and the slot machine prints a bar coded ticket having the tracking number. The printed ticket may be used to start play on another slot machine or cashed out at a cashier station. Once the bar coded ticket is redeemed, the tracking number is invalidated. Accurate accounting of these alternative forms of notes requires that they be validated upon receipt, and the validation or authentication requires electronic communication with the casino's central computer system in order to cancel out the ticket. Presently, these types of bar coded tickets issued by a slot machine can not be accepted at a gaming table as the gaming table does not have a validator communicating with the central computer system to check the authenticity of the tracking number of the bar coded ticket.

A few attempts have been made to patent the use of a bill acceptor assembly on electronic gaming tables. For example, U.S. Pat. No. 5,775,993 (“the '993 patent”) issued to Fentz et al. discloses a bill acceptor assembly mounted at each player station located around an electronic roulette wheel. Similarly, in U.S. Pat. No. 5,588,650 (“the '650 patent”), each player console located around an automated roulette wheel includes a bill acceptor. In both of these patents, a computer, not a human being, directs the game. A player can insert money into the bill acceptor to earn credits at any time, even though the player may not be able to place a bet until the next betting period. Yet, both the '993 patent and the '650 patent have two fundamental flaws. First, both patents use traditional single-feed bill acceptors where the player must insert one note at a time into the bill acceptor. The bill acceptors in the '993 patent and the '650 patent are not designed to accept multiple notes at one time. At a gaming table, players may start their betting with a large sum of money which, in the configuration of the '993 or '650 patents, would require each player to feed each note one at a time into the bill acceptor. The effort involved in feeding each note can be time consuming and frustrating, and even more so if the bill acceptor does not accept every note on the first feeding attempt.

Second, incorporating a bill acceptor into a computerized gaming table does not involve the same difficulties as incorporating a bill acceptor into a conventional gaming table operated by a human dealer. On the computerized gaming table, a computer using preprogrammed software manages each player's credits, operates the game, calculates and pays out all winnings, and collects any losing wagers. No casino tokens or notes are dispensed until a player cashes out. On the other hand, a gaming table supervisor, dealer or operator has to do all of the cash intake, chip or token distribution and wagering transaction functions by himself or herself. In addition, the operator is given the responsibility of watching each player to ensure that he/she does not cheat. Neither the '993 patent nor the '650 patent explain or address the many concerns of how to incorporate the bill acceptor into a human operated gaming table. For example, neither patent discloses how the operator would know how much money has been inserted into the bill acceptor. This disconnect in information would prevent the operator from knowing how many tokens to give back to the player.

Accordingly, a system for accepting valid currency and rejecting counterfeit currency on a conventional gaming table would be beneficial to the gaming industry. Such a system would increase the casino's profitability by decreasing the amount of counterfeit currency it may receive. Moreover, a bill acceptor capable of accepting and validating a stack of notes would significantly decrease the delay involved in feeding one note at a time into the bill acceptor. Implementation of bill acceptor's into the operation of gaming tables in a casino environment allows a number of additional improvements over the existing methods of operation. In view of the degree of sophistication involved and the necessary design and operation of such a bill acceptor that will be serviceable in the gaming industry, it may also be appreciated that a bill acceptor satisfying the requirements of the gaming industry will have wide application to a number of applications, including for example self serve kiosks and checkout counters.

### SUMMARY OF THE INVENTION

The present invention is directed to a note or bill acceptor, which will accept various notes, located on a gaming table. Due to the expansion of the types of currency and currency substitutes which are accepted by current bill acceptors on current casino gaming machines, bills, vouchers, script, tickets and currency will be hereinafter collectively referred to as “notes.” The bill acceptor of the present invention is directed to providing an efficient way to accept notes on a gaming table and simultaneously discriminate between authentic and counterfeit notes. Accordingly, a bill acceptor for accepting and rejecting notes on a gaming table is set forth which includes a validator assembly having a slot for receiving notes and an associated transport mechanism to pull the notes from the slot through the validator assembly. If the note is not authentic, the note can be transported to a bill rejection slot. If the note is authentic, the transport mechanism directs the note through an enclosed path down through (or around) the surface of the gaming table to a cash box. The bill acceptor is mounted to the gaming table with a mounting bracket, preferably so as to take advantage of the existing slot in the top of the gaming table into which the dealer or operator would normally insert the notes.

According to the present invention, a player or the dealer places a single or multitude of notes down a wide slot leading to a bill acceptor. The bill acceptor removes one note at a time from the others and uses various optical and magnetic sensors to determine the authenticity of each note. If the note does not meet the standards of the bill acceptor for any reason, the note is rejected. The transport mechanism may divert the rejected note to a bill rejection slot, where the note is returned to the playing surface of the gaming table. An override “Accept” function or button, to allow the dealer to accept a questionable note, is also contemplated to allow the dealer to accept the notes, even though the bill acceptor is rejecting them. Alternatively, the rejected note may nonetheless be accepted with the remainder of the valid currency, for a variety of reasons, if the bill acceptor software is programmed accordingly. If the note is valid, a transport mechanism conveys the note to a cash box for storage. A display may indicate the total value of the notes received.

The accepted notes may be securely and orderly stacked inside the cash box if the cash box is configured to include a stacker. A lock on the cash box door prevents unauthorized access to the notes inside the cash box. Moreover, the bill acceptor and cash box can be assembled from more than one component to ensure ease of installation onto the gaming table. Further, a bill guard can be installed around the bill acceptor to minimize the possibility that a player would reach over the gaming table and attempt to remove the notes as they were being fed into or rejected from the bill acceptor.

Incorporation of the bill acceptor into the gaming table allows for significant improvements in the protection against fraudulent practices as well as the event auditing for each gaming table. The bill acceptor is communicatively coupled to the casino's central computer system, either by hard wiring or wireless communication systems. The bill acceptor can be programmed to identify and accept counterfeit notes while notifying security or supervisory personnel of the receipt of such a note or notes. The bill acceptor can also be programmed to allow for a full event auditing of all transactions, including credit issuances, markers, token fills voided tickets and markers and other types of casino transactions. Further, the fill acceptor may be configured to provide information on the exact status of all transactions to the Pit Boss, either upon activation of a display or reporting function or via a hard wired or wireless communication system.

The above described and many other features and advantages of the present invention will become apparent from a consideration of the following detailed description in conjunction with the accompanying drawings.

### BRIEF DESCRIPTION OF THE DRAWINGS

FIG. 1 is a perspective view of a gaming table with an installed bill acceptor.

FIG. 2 is a representative cross sectional view of the bill acceptor and a cash box assembly.

FIG. 3 is a perspective view of a mounting bracket for mounting the bill acceptor to the gaming table.

FIG. 4 is a perspective view of a cashbox housing and power assembly of the bill acceptor.

FIG. 5 is a perspective view of an alternative configuration for a bill acceptor and a bill guard installed on a gaming table.

FIG. 6 is a perspective view of another alternative embodiment of a bill acceptor for mounting on a gaming table.

FIG. 7 is a perspective view of an alternative embodiment of a bill acceptor.

FIG. 8 is a schematic representation of a system that interconnects the bill acceptors on multiple gaming tables with a computer system according to the present invention.

FIG. 9 is a schematic diagram of system event transactions for the bill acceptor.

### DETAILED DESCRIPTION OF THE PREFERRED EMBODIMENTS

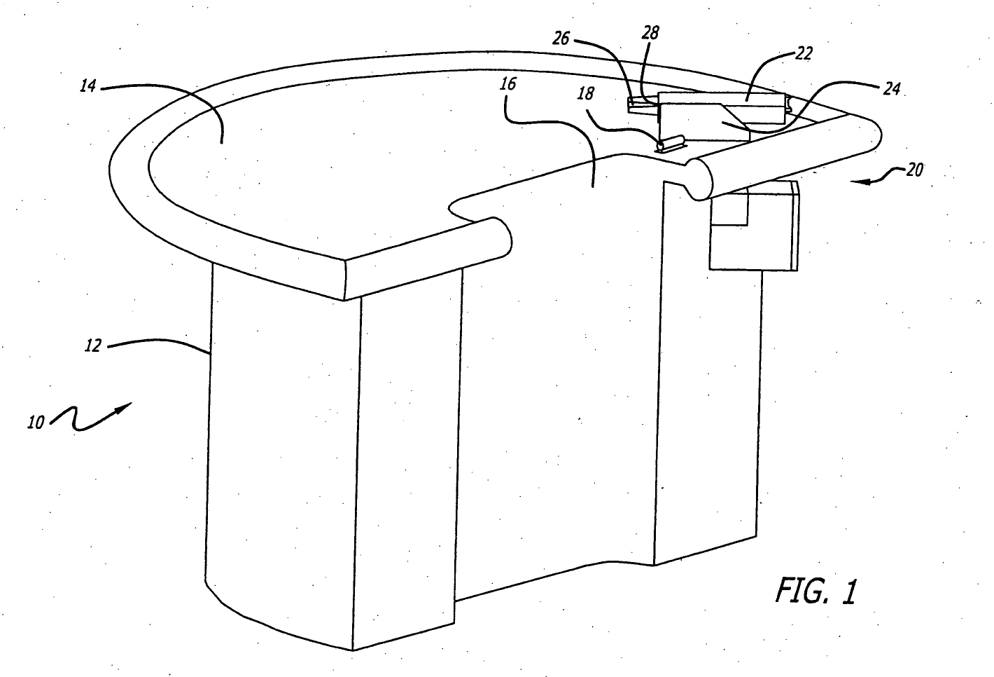

FIG. 1 provides a perspective view of a card type of gaming table 10 having a base 12 and a playing surface 14. The gaming table 10 as depicted has a dealer station 16 opposed by semi-circularly arranged player positions. The gaming table 10 will normally have a drop slot 18, positioned proximate the dealer station 16, which defines a hole in the gaming table 10 and allows for notes to be deposited into a cash box contained proximate the base 12, or within the base. While a card type gaming table is depicted, the invention is applicable to other types of gaming tables such as craps tables and roulette tables.

As further illustrated in the exemplary embodiment of FIG. 1, a bill acceptor 20 is positioned on the playing surface 14 of the gaming table 10. The bill acceptor 20 includes a housing 22 and a mounting bracket 24 to secure the housing 22 to the gaming table 10. The housing 22 includes a bezel 26 upon which notes can be stacked and sequentially fed through a slot 28 into the bill acceptor 20. The slot 28 generally comprises an opening dimensioned to receive the notes.

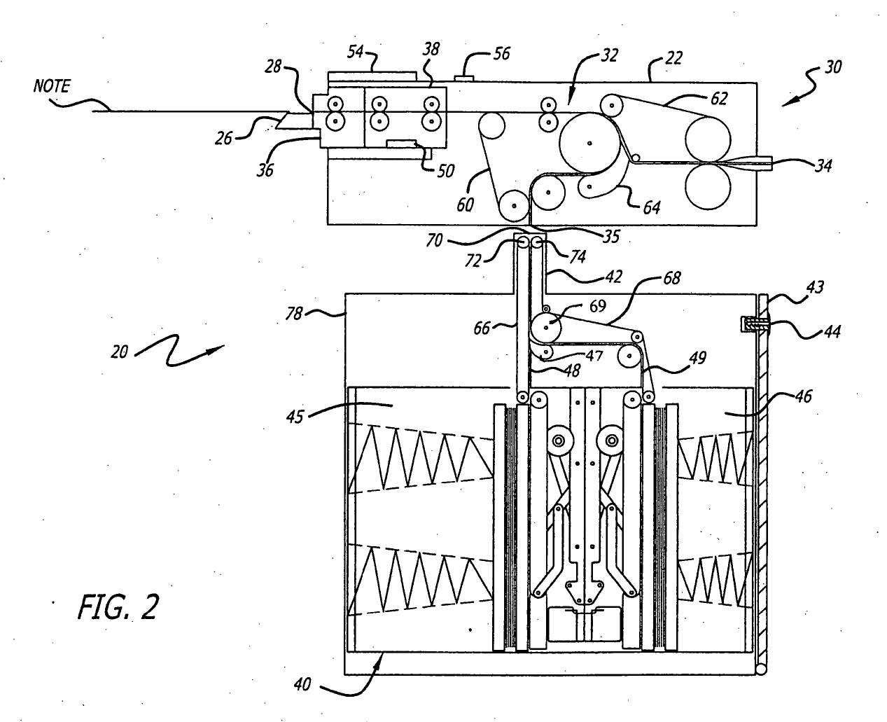

FIG. 2 depicts a cross-sectional view of the bill acceptor 20 and an associated cash box 40 removed from the gaming table 10 of FIG. 1. Within the bill acceptor 20, the notes are transported through a validator assembly 30 by a transportation assembly 32, as discussed below. A bill separator 36 may be located proximate the slot 28. The notes pass from the bill separator 36 through a bill discriminator 38 to determine if the notes are authentic. The bill acceptor 20 also includes, at an opposite end of the housing 22, a bill dispenser slot 34. In the event that the bill discriminator 38 determines that a note inserted into the validator assembly 30 is not authentic, the transportation assembly 32 passes the note through the housing 22 to the bill dispenser slot 34.

As illustrated, notes are to be inserted into the bill acceptor 20 through the slot 28. Notes rejected by the validator assembly 30 are ejected through the bill dispenser slot 34. Valid notes are deflected downward through a slot 35 located on the underside of the housing 22 which is to be positioned over the drop slot 18 of the gaming table 10. In an alternative embodiment, the notes are directed to a location along the back edge of the gaming table 10 to then be transported to the cash box 40.

A power assembly 42 draws the valid notes away from the validator assembly 30 and deposits them into the cash box 40, which is to be mounted below the playing surface 14 of the gaming table 10. The power assembly 42 also supplies power to and exchanges information with the validator assembly 30 through a power connector located on the underside of the housing 22 as discussed below. The cash box 40 is contained within a cash box housing 41 having a cash box door 43 and a door lock 44 to prevent unauthorized access to the contents of the cash box 40. The cash box 40 may simply be an open container having a slot in the top through which the notes are inserted. As depicted in FIG. 2 the cash box 40 receives and stacks the notes. While the cash box 40 may have a single stacker for all of the notes, it may be preferable to have two stacker sections as depicted, wherein first stacker section 45 receives and neatly stacks currency. A second stacker 46 can be used to stack a selected currency denomination or alternatively all non-currency notes accepted by the bill acceptor. As another alternative, the second stacker 46 could be used to store “fill slips” signifying additional chips being brought to the gaming table. Thus, the second stacker 46 could be used to store all documents, or all non-currency items, received by the bill acceptor. Accordingly, for this dual stacker cash box, the power assembly 42 will have a transport system and a deflector 47 to allow the notes to be directed to the appropriate stacker along a first transport path 48 or a second transport path 49.

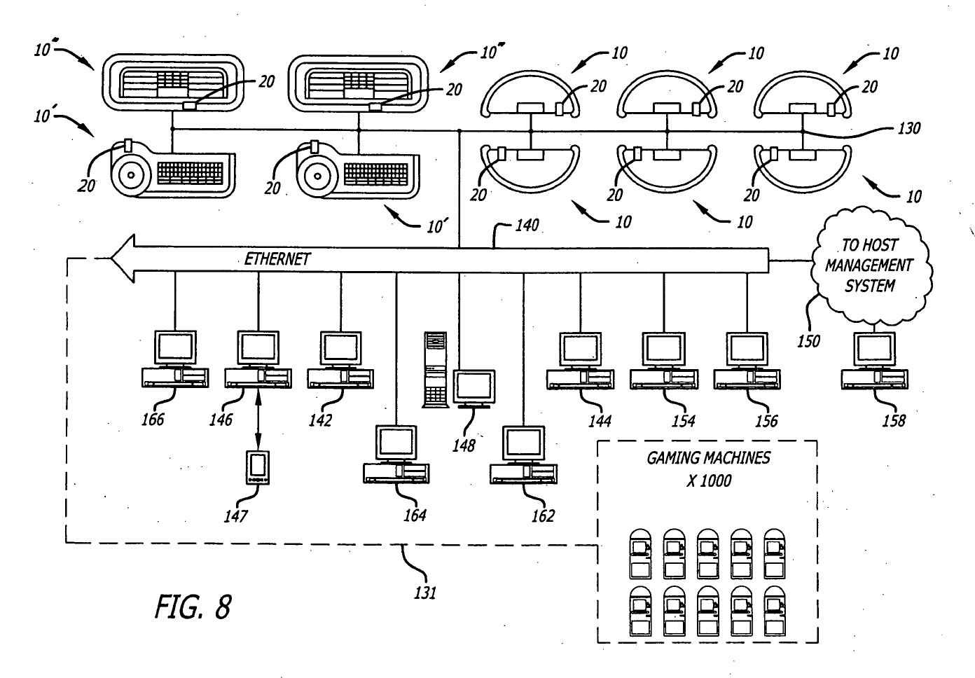

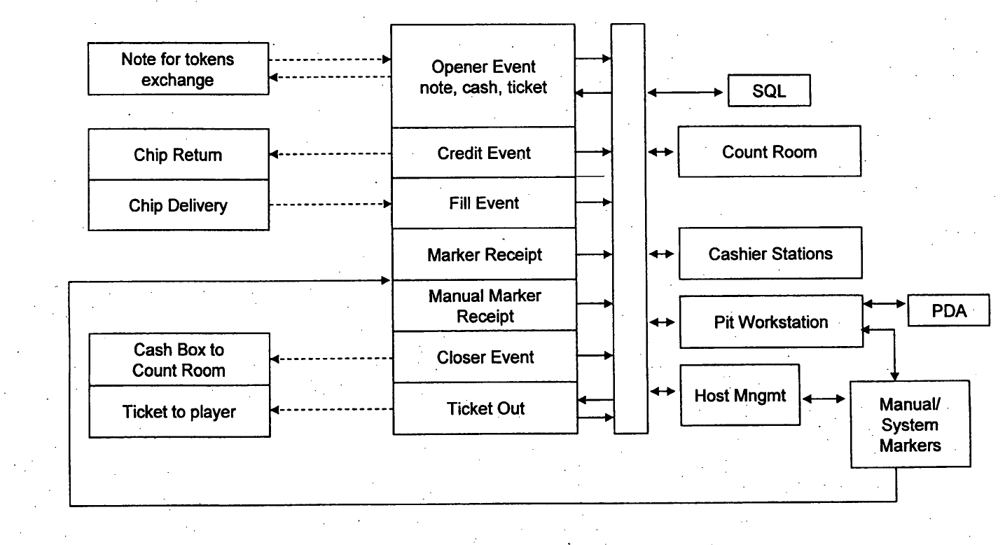

The validator assembly 30 contains a circuit board mounted validator processor 50 which is also preferably connected to a central computer or server (shown in FIG. 8) of the casino. The validator processor 50 has various processing capabilities which are known in the art. Upon receipt of a note and determination of validity, a signal is sent to the casino processor or server signifying receipt as well as the denomination of the note. The value of the notes accepted by the validator assembly 30 can then be displayed on an LCD display 54.

There may be situations where some or all of the notes received are rejected from the validator assembly 30 even though it may be apparent to the dealer that the rejected notes are authentic. In this and other situations, the dealer may want to accept the notes in spite of the refusal of the validator assembly 30. To override the decision of the validator assembly 30, the dealer could activate an override input, such as an Accept button 56 which is electrically connected (not shown) to the validator processor 50. Pressing the Accept button 56 will force the validator assembly 30 to accept the notes and the transportation assembly 32 to transport the notes to the cash box 40. Software associated with the bill acceptor 20 can be provided to keep track of the number of notes received as a result of the dealer overriding the validator assembly 30.

If a player wants to place a bet with a dealer operating a casino game on the gaming table 10, casinos generally require the player to use the casino's own tokens to play. The player may already have casino tokens in possession or may give notes to the dealer who will exchange the notes for an equivalent value of casino tokens. To validate the notes received from the player, the dealer or player places the stack of notes on the bezel 26. The bill separator 36 pulls off one note at a time through the slot 28. The technology of bill separators is known in the art, which includes feeding devices such as printers, photocopiers, currency counters, and automated teller machines that feed one sheet of paper, such as a note, from a stack of paper or notes.

The notes are then pulled into the bill discriminator 38 by the transportation assembly 32. Because they are electrically connected to one another, the bill discriminator 38 can instruct the transportation assembly 32 to direct and transport validated notes into the cash box 40 and invalid notes to the bill dispenser slot 34. The transportation assembly 32 includes belts 60 and 62 that transport the note from the bill discriminator 38 to the deflector 64. Depending on the authenticity of the note processed, the bill discriminator 38 will send a signal to a deflector 64 which directs the pathway of the note through the validator assembly 30. If the note is authentic, the deflector 64 will remain in an initial position to direct the notes downwards towards the cash box 40. In the event the note is not authentic according to the bill discriminator 38, the deflector 64 moves from the initial position to a secondary position to deflect the note to an exit or horizontal pathway out of validator assembly 30.

It is understood that the transportation assembly 32 discussed above is an exemplary embodiment for illustration purposes only. Other transportation systems well known or apparent to one skilled in the art are to be included within the scope of the present invention. In addition, in an alternative embodiment, the slot 28 and the bill dispenser slot 34 may be the same.

As illustrated in the cross-sectional view of FIG. 2, the transportation assembly 32 transports valid notes past the deflector 64 to slot 35, which is positioned opposite a narrow extension of the power assembly 42, configured to extend up through the drop slot 18 of the gaming table 10. At the top of the narrow extension is a slit 70 into which the notes are directed. After entering the slit 70, the note passes between two wheels 72 and 74, driven by belts 66 and 68, respectively which draw the note down towards the cash box 40 and away from the validator assembly 30. The belt 66 extends down to the top of the cash box 40 to direct notes to the first stacker 45 of the cash box 40 if a deflector 47 is in an initial position according to the type of note. Belt 68, driven by a motor drive 69 and passing over or around various idler wheels, drives belt 66 and controls the direction of notes directed to the second stacker 46 of the cash box 40 if the deflector 47 moves to a second position.

The bill acceptor 20 may be composed of multiple modules that facilitate installation on a gaming table 10, including for example the mounting bracket 24, the validator assembly 30, and the cash box housing 78 which contains the power assembly 42 as well as the cash box 40. The validator assembly 30 can be an independent component and compact assembly, for example, about the width and length of two U.S. currency bills placed consecutively lengthwise. The mounting bracket 24 is adapted to receive and securely hold the validator assembly 30 to the gaming table 10.

As illustrated in FIG. 3, the mounting bracket 24 may have a base plate 84 that is connected to two plates 86 extending upward and two plates 88 extending downward. The base plate 84 has an opening 90 that is similar in size to the opening of the drop slot 18. The upward plates 86, which rise upward from the base plate 84 and contain overhangs 92 and 94, secure the validator assembly 30 from the top, underside, and each side parallel to the length of the validator assembly 30. A locking mechanism may be provided on the validator assembly 30 so that it can mate and lock with a lock receiver to secure the validator assembly 30 to the mounting bracket 24.

The plates 88, which extend downward from the base plate 84, are parallel to the wider wall of the drop slot 18. The lower ends of the plates 88 extend down the full length of the drop slot 18. At the lower end, the plates 86 may include flanges 96 that clip to the underside of the gaming table 10. To install the mounting bracket 24, the plates 88 are inserted into and pushed through the drop slot 18. After the flanges 96 extend past the end of the drop slot 18, the flanges 96 grip onto the gaming table 10, preventing the removal of the mounting bracket 24. To remove the mounting bracket 24 from the gaming table 10, the flanges 96 must be squeezed together from below the gaming table 10.

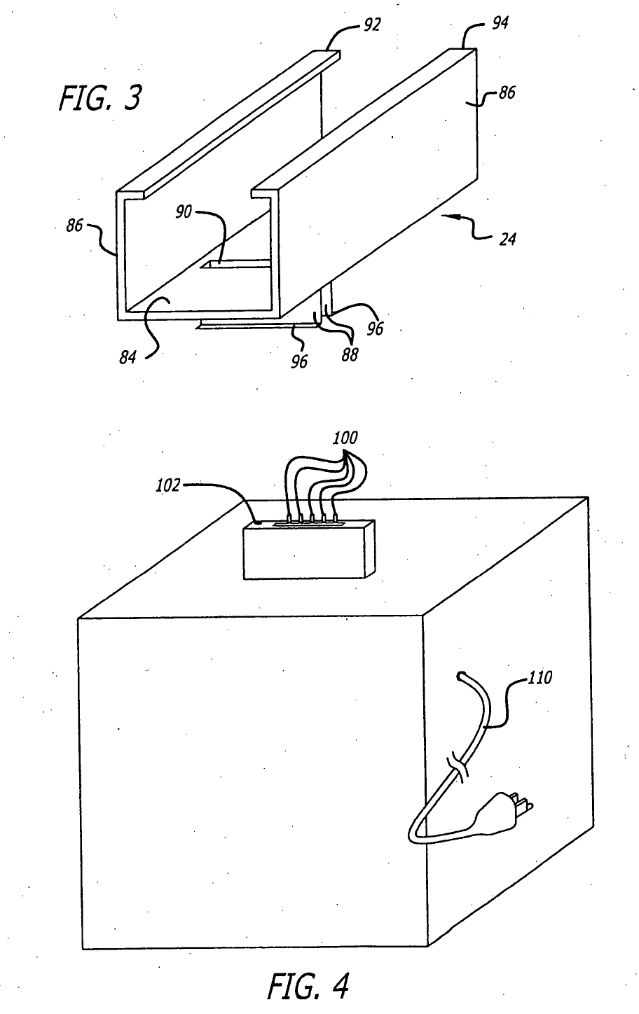

As illustrated in FIG. 4, the top of the narrow extension of the power assembly 42 includes a plurality of pin contacts 100 located extending from the power assembly 42 toward the validator assembly 30. The pin contacts 100 may be spring-loaded to maximize contact between the pin contacts 100 and contacts located on the base of the validator assembly 30. The pin contacts 100 and contacts on the validator assembly 30 are made of alloys that allow transfer of electrical power and data between the validator assembly 30 and the power assembly 42. Alternatively, pin contacts 100 may be used primarily to transfer power from the power assembly 42 to the validator assembly 30, whereas an optical coupling device 102 on the power assembly 42 communicates with an optical coupling device on the validator assembly 30 to transfer data information.

The pin contacts 100 are attached to a power supply and controller in the power assembly 42. A cable 104 can be provided to couple power to the power assembly 42 and also electrically couple the controller of the power supply 42 to a computer server (shown in FIG. 8) in the casino. Alternatively, wireless technology can be used to communicate information between the bill acceptor 20 and a computer server in the casino.

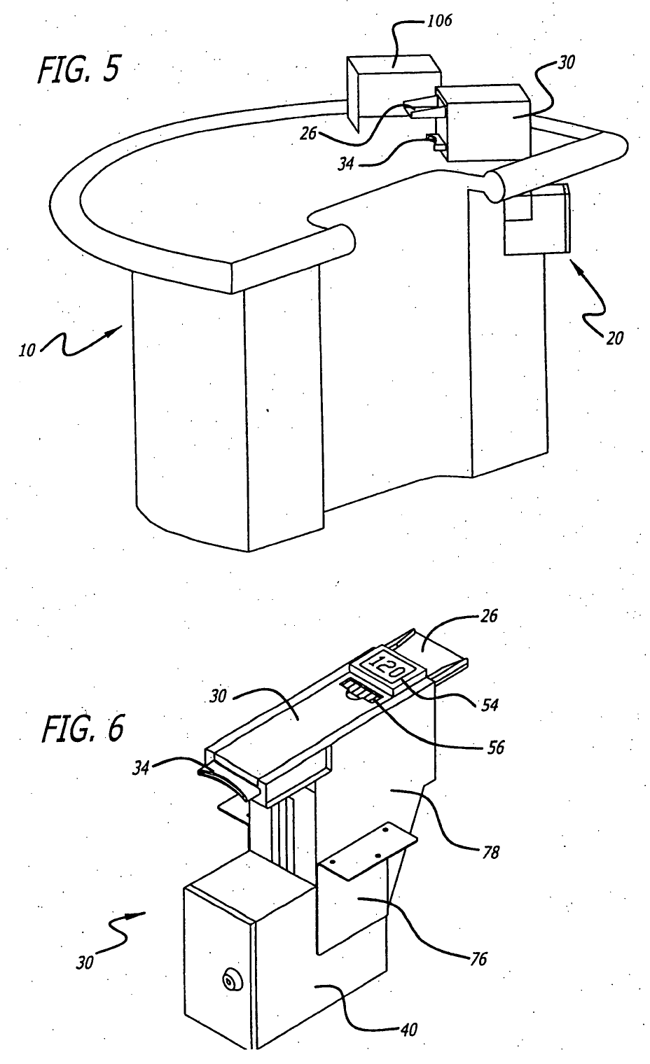

As illustrated in FIG. 5, a bill guard 106 attaches to the gaming table 10 and is positioned near the bill acceptor 20. The bill guard 106 minimizes the possibility that a player could reach onto the gaming table and remove the notes as they were being fed into or rejected from the bill acceptor. The bill guard 106 can be made of a translucent material such as high impact plastic. The bill guard 106 will allow the dealer and players to watch the bills as they are inserted into or rejected from the validator assembly 30. The bill acceptor 20 depicted in FIG. 5 is an alternative embodiment, where the bezel 26 and the bill dispenser 34 are positioned on the same side of the validator assembly 30.

As depicted in an alternative embodiment in FIG. 6, the bill acceptor 20 is enclosed within an integrated housing 78 containing the cash box 40. To install the bill acceptor 20 on the gaming table 10, a hole is cut into the gaming table 10. The hole may need to be larger than the drop slot 18. The bill acceptor 20 is mounted through this hole such that the validator assembly 30 is above the playing surface 14 and the cash box 40 is below. Mounting members 76 are provided to secure the bill acceptor 30 to the gaming table 10. The internal components of the bill acceptor 30 in the exemplary embodiment, such as the transportation assembly 32, bill separator 36, and the bill discriminator 38, would be used in this alternative embodiment.

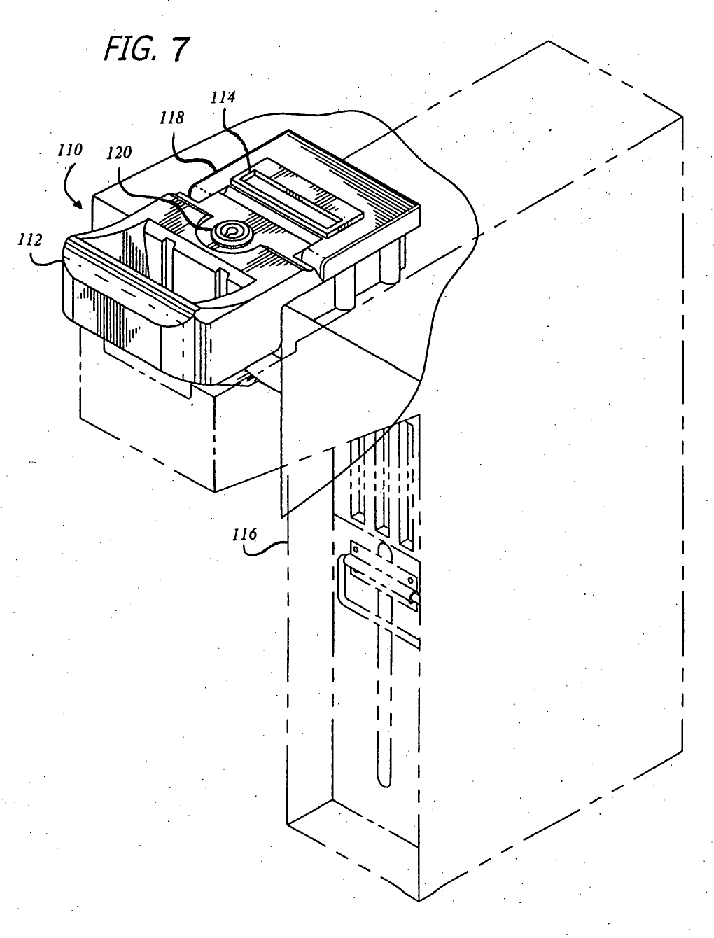

FIG. 7 depicts another embodiment of the invention. In FIG. 7, bill acceptor 20 is to be mounted on the gaming table in a manner whereby a bulk note feeder assembly 110 is positioned at the edge of the gaming table next to where the dealer will stand. The bulk note feeder assembly 110 includes a bulk note chute 112 having a tapering and curving cross sectional configuration allowing the dealer to insert a stack of up to twenty or thirty notes into the bill acceptor 20. The bill separator described above will be enclosed in a housing 116 and positioned opposite a bottom opening of the bulk note chute 112 to sequentially pull the notes from the bulk note chute 112 into the bill acceptor 20. Notes to be rejected (if the computer software is so programmed) are passed to a note dispense slot 114 positioned on the gaming table inset from the bulk note feeder assembly 112. The bulk note feeder assembly 110 is pivotally mounted to an assembly 118 such that the bulk note feeder assembly 110 can swing upward and provide access to the bill separator and validator assembly within the housing 116. A lock assembly 120 is provided to fix the bulk note feeder assembly 110 in place.

FIG. 8, schematically depicts multiple gaming tables 10 each having bill acceptors 20 that are interconnected over a low-level network 130 to an Ethernet 140. FIG. 8 shows six card tables 10, two roulette tables 10′ and two craps tables 10″, however, it is to be understood that any type and number of tables 10 can be interconnected and that multiple groups of tables, each group being overseen by a Pit Boss, may be interconnected. The Ethernet 140 may also be connected to a gathering processor 142 which is responsible for gathering game-related information from each bill acceptor 20 at each game table 10 via network 130 and for transferring the game-related information to other computers on the Ethernet 140. Gathering Processor 142 relays this information to a router 144. Router 144 is the router for the Ethernet 140. The data received by the router 144 is relayed to the pit workstation 146 and to the structured query language Database Server 148, the Database Server 148 houses the system database for the casino and, in most cases, the majority of the system applications themselves. In addition to the validators of the various gaming tables, the Database Server 148 may also be interconnected via the Ethernet 140 or a second low level network 131 to a plurality (n) of gaming machines within the casino, or within other casinos, and to the note validators therein. This interconnectivity allows the Database Server 148 to control the printing and cancellation of tickets at the gaming machines as well as at the gaming tables.

In the foregoing system, the pit workstation 146 is the primary interface between pit personnel responsible for a group of gaming tables 10 as shown in FIG. 8, and the interface with the Database Server 148 and a host management system 150. The pit personnel can view individual game or table information at the pit workstation 146 for a given game table 10 and execute system functions on the pit workstation 146 including printing of certain types of tickets and reporting to the Database Server 148. Optionally, the pit workstation 146 may be configured to couple with handheld or portable computer devices 147, such as personal data assistants (“PDA”), to download information directly to the PDA for pit personnel and/or the Pit Boss, so that the Pit Boss does not need to stay by the pit workstation 146 to receive updates.

The system of FIG. 8 also depicts a number of additional computers or workstations connected via Ethernet 140. The console computer 154 ensures that all functions and processes are conducted in accordance with the rules and regulations established by the users and administrators having authority to access the system. The player tracking gateway computer 156 serves as an interface between the host management system 150 and the marketing database of a casino management system. The host management system 150 may have an administrator terminal 158. The player-tracking gateway computer 156 enables the merge of slot and table tracking into a common database. Computers operating as the gathering processor 142, router 144, console computer 154, player tracking gateway computer 156 and the host management system 150 with its administrator terminal 158 may all be individual applications found within one computer such as the Database server 148.

The Ethernet 140 also provides the capacity for interconnecting the various computers to cash or vending kiosks 162 as well as to cashier stations 164 throughout the casino, either of which can provide players with a location to exchange vouchers, tickets and/or chips for cash. Further, the Ethernet 140 allows connection to the count room computer 166, located in the count room, so that all information available from the bill acceptors 20 located at each gaming table 10 is communicated to the count room. When a cash box from a bill acceptor 20 is delivered to the count room, the accumulated cash and other notes removed from the individual cash box can be verified against the electronically gathered information.

The network topology of FIG. 8 may vary considerably from casino to casino and from application to application. FIG. 8 is simply an illustration of an approach and is not meant to limit the teachings of the present invention as contained herein. The computer systems may be personal computer-based systems having conventional input such as keyboards, mouse controls, touch screens, bar code/ticket readers and printers. The teachings of the system of the present invention are independent of the specific nature and type of computer system and input devices as casinos generally have these computer components in place. The existing computer systems can be augmented to accommodate the advantages made available by implementation of the bill acceptors 20 at the gaming tables 10 with the addition of software modules and the appropriate hardware connections.

As in the case of the networked computer system, the specific implementation of the necessary software programs to integrate the present invention into a casino management system will need to be compatible with the existing or to be implemented software in the Database Server 148. The following discussion of the various functions to be implemented into the software module are therefore described in a manner to be exemplary in nature, it being understood that the concepts herein can be developed by those skilled with the various software operating systems utilized by casinos.

The provision of the bill acceptors 20 interconnected via the Ethernet 140 to the supervisory stations allows for a number of additional transaction or “Events” to be accounted for at each gaming table 10. There are a number of transaction events contemplated by the present system, as illustrated in the flow chart of FIG. 9. Transaction events include, by way of example only, coded tickets representing the following types of transactions:

An Opener Event is, for example, the receipt of a note, cash or ticket for example a ticket printed by a slot machine, from a player that is exchanged for tokens or chips when a player wishes to join or continue playing on the gaming table 10.

A Credit Event is a transaction in which a dealer at a gaming table returns chips to a cashier or chip bank in the casino in exchange for a credit ticket. The cashier prints a credit ticket that is returned to the dealer and credit ticket is inserted into the bill acceptor so that the system including the Database Server 148 and pit workstation 146 are advised that chips are being taken from a table and returned to a cashier or chip bank.

A Fill Event occurs when a game table 10 requires additional chips from a cashier station or chip bank. A Fill Event may be requested whenever a gaming table 10 is first opened as the table will need to be provided with chips. A Fill Event may also be required when there is a substantial buy-in by a player or when a player wins a substantial amount and the table requires additional chips. A Fill Event ticket is either printed at the gaming table 10 by the bill acceptor 20 or at the pit workstation 146. Once the Fill Event ticket is printed, it is taken to a cashier station to serve as the receipt of tokens from the cashier. The cashier scans the Fill Event ticket in a manner such that it is reported to the Database Server 148 and issues the tokens. The tokens, preferably with the Fill Event ticket, are then taken to the Gaming Table 10 and the Fill Event ticket is inserted into the bill validator 20.

A System Marker Event is the issuance of marker, or credit, provided to a casino patron. For example, a patron known to the casino may request from the Pit Boss or another supervisor that a marker be issued. Upon such a request, the Pit Boss may initiate a transaction whereby a marker ticket is printed, for example at the Pit Workstation 146 of FIG. 8, and accepted or signed for by a patron. The marker ticket is essentially a withdrawal from or charge against an account maintained by the casino for the specific patron. The issuance of the System Marker is reported to the Database Server 148, as well as to the host management system 150 and the count room. The patron (or Pit Boss) takes the marker ticket to a gaming table and the marker ticket is inserted into the bill acceptor 20 so that the dealer may issue playing chips or tokens in an amount equivalent to the value of the marker ticket.

The acceptance of the System Marker by the bill acceptor 20 is a System “issuance” to “receipt” Marker Receipt Event. The issuance of the System Marker is reported to the Database Server 148, as well as to the host management system 150 and the count room.

A Closer Event occurs when a gaming table is taken out of service and all chips are returned to the cashier station. The chips are counted and the Pit Boss or the cashier generates a closer ticket either at the pit workstation 146 or at the gaming table 10 on the bill acceptor 20. The closer ticket is inserted into the bill acceptor 20 where it is recorded. A copy may also be delivered with the tokens to the cashier station. When the cash box from the bill acceptor 20 is taken to the counting room, all of the transactions from the Opening Event to the Closing Event are tabulated and compared to the notes in the cash box including the transaction event tickets.

To allow for circumstances where communication with the casino's central Database Server 148 may not be available, provision is made to allow a Pit Boss to generate a Manual Marker. The Manual Marker may be a marker ticket that is issued on credit or against a deposit for selected patrons. A Manual Marker ticket may be printed for example at the pit workstation 146 causing a Manual Marker Event. When the Manual Marker is taken to the gaming table and accepted by the bill acceptor, whereupon a Manual Marker Receipt Event occurs, and the dealer issues to the player a selected number of chips represented by the Manual Marker. The Manual Marker Event and Manual Marker Receipt Event will be reported to the Database Server 148 when system communications are restored.

As will be appreciated by casino management personnel, the allowance for positive on-line validation and reporting of each of the foregoing transaction events is a substantial improvement in the overall accountability and security of gaming table transactions. Specifically, all interactions between the cashier stations, Pit Boss, player transactions, and the count room are reported to the Database Server 148. The reporting functions required by gaming control boards can be generated by the Database Server 148 on whatever schedule is desired. In addition, the Pit Boss can be freed up to attend to customer needs, and to more effectively monitor the games, as the pit workstation 146 and PDA 147 advise the Pit Boss of all significant transactions.

As noted above, the bill acceptor 20 can be programmed so that it will accept a number of different types of notes besides currency. The bill acceptor 20 may also preferably include a printer which allows the bill acceptor to print out various types of tickets including for example a cash out ticket that can be issued to a player. These features, together with the interconnection to the casino server system allow for a number of enhancements in the control of the table gaming events that benefit the patron. As a first example, by the incorporation of the bill acceptors 20 at each gaming table 10, a customer who receives a printed ticket from a slot machine type of gaming device having a ticket-in and ticket-out capabilities can provide the printed ticket at the gaming table. The ticket can be scanned and accepted by the bill acceptor 20 which interconnects through the network 130 to the Database Server 148 to verify the ticket that had been printed by the slot machine. Once the Database Server 148 validates the ticket, it sends a signal back to the operator of the game table (and the Pit Boss) to indicate the amount of money, in the form of tokens or chips, to be provided to the player/patron.

If necessary, any differential between multiples of the value of chips and the amount of a ticket can be printed and issued as a new ticket by the bill acceptor. For example, if a player provides a ticket having a value of $58 to a gaming table having a minimum chip value of $5, the bill acceptor 20 can print out a $3 ticket while the dealer distributes $55 in chips to the customer. In this configuration, the bill acceptor 20 reads the bar code on the ticket, sends a signal to the server 148 thereby providing the tracking number from the bar code of the ticket to the Database Server 148. The Database Server 148 checks the ticket number as against the issuance number which it provided when the ticket was printed by a slot machine and from that number determines if the ticket has previously been redeemed. If the ticket number has not been redeemed, then the Database Server 148 provides a signal to the bill acceptor 20 at the table 10 indicating the amount of credits to be redeemed against the ticket. The amount can be displayed to the dealer and optionally to the player on a display screen which may be included on the bill acceptor 20.

In view of the foregoing discussion, it may be readily understood that alternative embodiments are contemplated. For example, a slot for receiving money can be located proximate to each player position. Because the slot includes an opening adapted to receive notes, the slot could be located on the playing surface of the gaming table, along the border of the gaming table or under the playing surface of the gaming table. A player could insert a note into the slot or place the note on a bezel leading to the slot. A bill separator positioned proximate the slot could pull off one note at a time from the bezel. A transportation assembly generally similar to the system disclosed above would transport the note to a bill discriminator. There may be at least one bill discriminator per table to validate notes received from the slots. Valid notes may be transported to one central cash box or a plurality of cash boxes per gaming table. If one bill discriminator is installed proximate to each player position, a cash box may be installed proximate to each bill discriminator. This increases the number of cash boxes that need to be replaced by the casino personnel, but it also increases the cumulative note storage capacity on a gaming table. In addition, the increased storage capacity may decrease the frequency of replacements of filled cash boxes with empty ones. It is also possible to install only one central cash box per gaming table regardless of the number of bill discriminators. In such a configuration a transportation assembly positioned within or below the top of the gaming table will carry valid notes to a cash box and will return invalid notes to the player.

Once the bill discriminator determines the denomination and authenticity of the received note, the bill discriminator may send a signal to an LCD display 54 visible to the dealer and/or the player to indicate how much money a particular player has inserted. The LCD display 54 may indicate the total amount received, or list all of the bills and their amounts in addition to the total amount received. Further, by providing a numeric LCD display 54 showing the amount of received on the surface of the gaming table, security cameras can more readily monitor the intake of money or notes and disbursement of chips by the operator. After giving the equivalent amount in casino tokens to the player, the dealer can reset the reading on the LCD display. In this manner, the dealer can still control when the bets are placed, but doesn't waste time in collecting, counting and verifying the authenticity of the notes collected. In the event the notes are rejected, the notes may be returned through the slot used for inserting money or a separate slot for rejected notes.

Having thus described different embodiments of the invention, other variations and embodiments that do not depart from the spirit of the invention will become readily apparent to those skilled in the art. The scope of the present invention is thus not limited to any one particular embodiment, but is instead set forth in the appended claims and the legal equivalents thereof

1. A casino table game transaction management system for a plurality of gaming tables each having a dealer station and at least one player station, the system comprising:
a plurality of bill acceptor assemblies adapted for utilization at said gaming tables, said bill acceptor assemblies each including a note transportation system, a note validator configured to identify characteristics of each note being passed therethrough by said transportation system, and a cash box adapted to receive and to store notes;
a casino computer configured to monitor transactions within the casino; and
a network interconnecting each of said bill acceptor assemblies at said gaming tables to said casino computer.

2. The casino table game transaction management system of claim 1, wherein said note validator is configured to validate currency, bar coded tickets, casino scrip or vouchers.

3. The casino table game transaction management system of claim 1, further comprising:
a plurality of computers positioned throughout the casino and interconnected through said network to said casino computer.

4. The casino table game transaction management system of claim 1, wherein said plurality of computers positioned throughout the casino include at least one of:
a pit workstation computer;
a cashier station computer; and
a count room computer.

5. The casino table game transaction management system of claim 2, further comprising:
network communication components for communicating information from a plurality of gaming machines to said casino computer whereby cash out tickets issued at said gaming machines may be redeemed at said gaming table when validated by one of said bill acceptor assemblies.

6. The casino table game transaction management system of claim 1, wherein each of said bill acceptor assemblies further comprises:
a display to indicate the value of the notes received into and validated by said note validator.

7. The casino table game transaction management system of claim 1 wherein said management system is programmed to allow automation of a number of event transactions selected from the group consisting of: an Opener Event, a Credit Event, a Fill Event, a System Marker Event and a Closer Event.

8. The casino table game transaction management system of claim 4 wherein the denomination of each note received by one of the bill acceptor assemblies is communicated to said pit workstation.

9. The casino table game transaction management system of claim 4, further comprising:
at least one personal data assistant device communicatively coupled to said pit workstation to receive information concerning all transactions by each of said bill acceptor assemblies within a designated grouping of gaming tables.

10. The casino table game transaction management system of claim 1 wherein said note validator is programmed to accept non-currency notes including bills, vouchers, script, and tickets.

11. The casino table game transaction management system of claim 1 wherein notes determined to be invalid are retained by said bill acceptor assembly and said note validator communicates a signal indicating the receipt of an invalid note to said casino computer.

12. The casino table game transaction management system of claim 1, wherein said bill acceptor assemblies further comprise:
a printer for printing a cash out ticket the value of which is communicated to said casino computer which assigns a specified code to be printed on said ticket.

13. The casino table game transaction management system of claim 1 wherein said casino computer receives information from said note validators of said bill acceptor assemblies and keeps track of the denominations of all currency received and stored in said cash box of each of said bill acceptor assemblies.

14. The casino table game transaction management system of claim 13 wherein said cash box further comprises a memory device coupled to said note validator so that the denominations of all currency deposited into said cash box are stored in said memory.

15. The casino table game transaction management system of claim 10, further comprising:
at least one personal data assistant device communicatively coupled to receive information concerning all transactions by each of said bill acceptor assemblies within a designated grouping of gaming tables.

16. The casino table game transaction management system of claim 13, further comprising:
at least one personal data assistant device communicatively coupled to receive information concerning all transactions by each of said bill acceptor assemblies within a designated grouping of gaming tables.

17. The casino table game transaction management system of claim 1 further comprising:
a bulk note feeder chute positioned proximate said dealer station to receive notes to be provided to one of said bill acceptor assemblies.

18. The casino table game transaction management system of claim 1, further comprising:
printing a marker ticket issued for a selected player, the amount of said marker being reported to said casino computer; and
bill acceptor assemblies wherein a code printed on said marker ticket is read by said validator, the code is forwarded to said casino computer, said casino computer verifying the amount of said marker and crediting the respective gaming table with having received the marker.
